(19) United States
(12) Patent Application Publication
(10) Pub. No.: US 2014/0021715 A1
(43) Pub. Date: Jan. 23, 2014

(54) Squareness Indictor for Pipe Flanges

(71) Applicant: Zachary Craig STALLINGS, Jasper, GA (US)

(72) Inventor: Zachary Craig STALLINGS, Jasper, GA (US)

(21) Appl. No.: 13/553,130

(22) Filed: Jul. 19, 2012

(51) Int. Cl. F16L 23/00

(52) U.S. Cl. CPC F16L 23/003
USPC 285/93

(57) ABSTRACT

A visual tool to enable unskilled workers to properly tighten connections flanges at a pipe joint utilizes a formed shim having opposing abutment portions defining coaxial bolt holes. When the shim is placed on connecting bolts between the flanges compression of the shims provide a visual indication of uniform tightening of the flange bolts.

### BACKGROUND OF THE INVENTION

The present invention relates to the field of joining metal pipe using raised face flanges of the ASME variety. The invention also has application to the use of such flanges in bolting piping to pumps, valves, traps, and any machinery.

The bolted joint has been around for centuries, and for that time span the novice or uninformed installer often uses improper techniques in putting the joint together. Raised face flanges are commonly used in the industry and typically include an annular face, positioned adjacent the pipe to be connected, which has a thickness that is greater than the thickness of the portion of the flange circumferentially surrounding the raised face. Thus, when opposing flanges are mounted on two pipes with the raised faces abutting a gasket placed there between, a circumferential space is formed between the outer portions of the flanges. Typically, a flange connection includes two flange components with aligned circumferential bolt holes extending through the flange components parallel the axis of the pipe to be joined. Bolts are inserted through the aligned bolt holes and tightened to make the connection. The non skilled installer tends to tighten one bolt completely and work sequentially around to the other bolts. This creates a condition called “flange rotation”, wherein the first over tightened bolt creates a fulcrum effect urging the periphery of the flanges closer together adjacent the first tightened bolt and preventing proper tightening of the bolts on the opposite side of the pipe. The result is insufficient loading on the rotated side of the flange and too much load on the side over tightened adjacent the first bolt.

### SUMMARY OF THE PRESENT INVENTION

It is an object of the present invention to give the installer a visual conformation that the flanges are aligned and true, that one bolt isn't tightened more than another causing a rotated flange.

The device also allows the installer a physical clue that he is starting his installation properly (i.e.: square and aligned).

It is a further object of the invention to reduce the cost of routine maintenance of flange connected pipe, by providing a simple tool to enable unskilled workers to properly tighten flange bolts.

These and other objects and advantages of the invention will become apparent from the following detailed description of the preferred embodiment of the invention.

### BRIEF DESCRIPTION OF THE DRAWINGS

An article of manufacture for use as a visual and physical aid to determine flange perpendicularity is depicted in the accompanying drawings which form a portion of this disclosure and wherein:

FIG. 1 is a plan view of a die cut for the flange shim;

FIG. 2 is a perspective view of the flange shim;

FIG. 3 is a second perspective view of the flange shim; and

FIG. 4 is a side elevation view of a pipe connection using the flange shims.

### DESCRIPTION OF THE PREFERRED EMBODIMENT

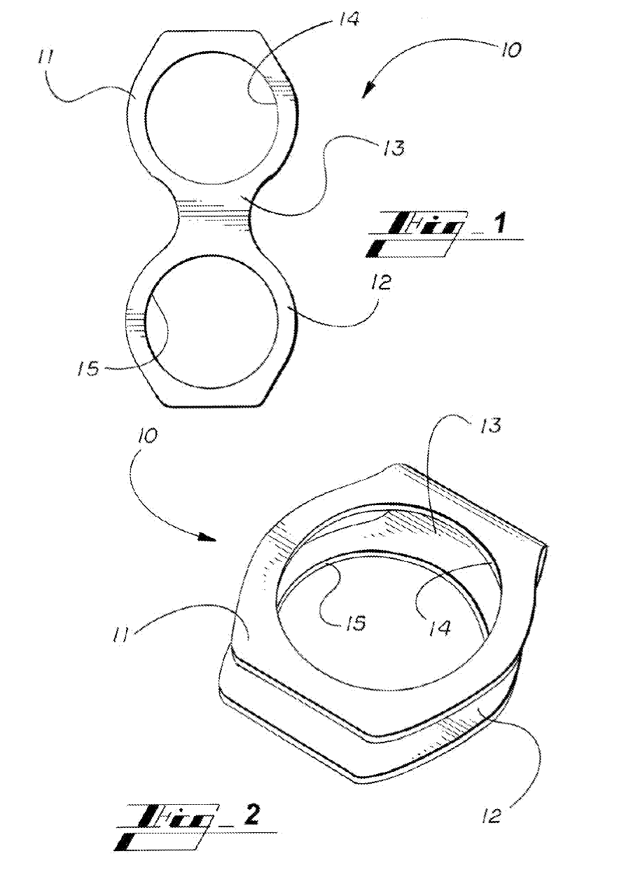

Referring to the FIGS. 1-4 for a clearer understanding of the invention, it may be seen that the preferred embodiment of the invention contemplates an article of manufacture which is used with raised face flanges employed to join two pipes or similar structures. Raised face flanges are commonly used in the industry and typically include a face surrounding the pipe to be connected which has a thickness that is greater than the thickness of the portion of the flange circumferentially surrounding the raised face. Thus, when opposing flanges are mounted on two pipes with the raised faces abutting a gasket placed there between, a circumferential space is formed between the outer portions of the flanges. The present invention provides the unskilled worker with a quick visual reference as to whether the flange faces have remained square or substantially parallel as he tightens flange connection.

Referring to FIG. 1, one embodiment of the invention may be made by die cutting appropriate stainless steel shims 10 from sheet metal As shown in FIG. 1, the shim 10 is initially formed as a blank having a thickness appropriate for the flange connection with which it will be used. By way of example the shim 10 may be made from 304 stainless steel sheet having a 0.020 inch thickness. The blank may also be stamped from 316 stainless steel or any other suitable non-corrosive and mailable material. In the embodiment shown it will be appreciated that the blank has a generally FIG. 8 shape, however, it is to be understood that the specific shape is not critical to the invention. The blank has a first abutment portion 11 and a second abutment portion 12 joined by a central portion 13. Each abutment portion has an inner edge 14 and 15 respectively which defines a bolt hole on either side of central portion 13. The bolt holes are sized appropriately to receive there through a bolt such as would be used to connect a pair of flanges.

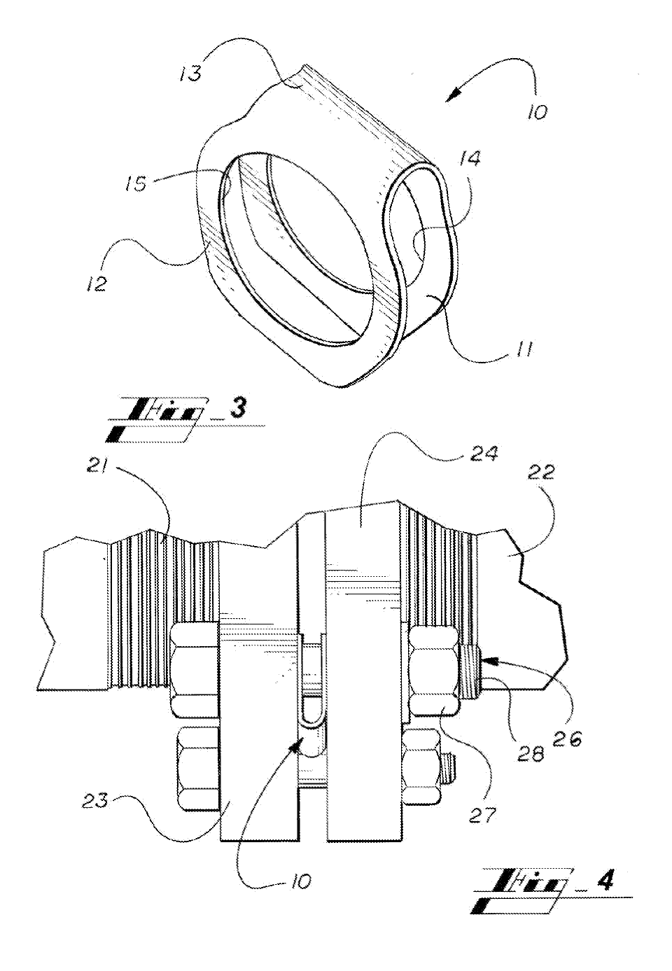

Referring to FIGS. 2 and 3, it will be seen that shim 10 is formed into its operative configuration by bringing abutment portions 11 and 12 into near parallel relationship and the bolt holes defined by edges 14 and 15 into coaxial alignment. The term mailable in this application means that the blank may be physically bent or deformed to bring the abutment portions and bolt holes into the described configuration where they will remain until additional forces act to alter the position. Center portion 13 has to have sufficient mass to allow the bending of the shim into this configuration. The exact curvature assumed by central portion 13 is not critical as long as portions 11 and 12 assume their intended positions, thus, the shim could be formed with two bends at the intersection of the central portion with the two abutment portions and the central portion 13. By way of example, the shim blank may be formed from 0.020 steel and have an is overall length of about 2.25 inches. Abutment portions 11 and 12 may have an outer diameter of 1 inch and the inner edges 14 and 15 may define bolt holes which have a diameter of about 0.75 inches. It is to be understood that the specific bolt hole size will be determined by the size bolts being used in the particular flange installation. When the shim 10 is shaped to bring the abutment portions 11 and 12 into alignment, the separation between them will be about 0.25 inches or less. Other dimensions may be appropriate for particular applications however all of the shims should have a uniform separation for their specific application.

Referring to FIG. 4, it may be seen that two pipe sections 21 and 22 are to be joined at their threaded portions by a flange connection. Each pipe 21, 22 carries a flange 23, 24 of the raised face type previously discussed. The raised faces are brought into abutment with a circumferential gasket, not shown. A plurality bolt and nut combinations 26 serve to connect the flanges. Each bolt 27 passes through one of the flanges 23 and then through both bolt holes of a shim 10 before passing through flange 24 for connection with nut 28. Thus, each bolt 27 will have a shim 10 mounted on it intermediate flanges 23 and 24. It should be understood that the shims are single use products that remain on the bolt 24 for as long as the joint is secured. Abutment portions 11 and 12 will abut the inner surfaces of flanges 23 and 24 and should provide uniform resistance to the compression of the gasket between the raised faces of the flanges. Thus, the user may look at the circumference of the flanges when they are in position to be tightened and note the visual uniformity of the shims. The resistance to further tightening should occur prior to or concomitantly with the faces of the flanges contacting the gasket. Thus, this product starts the flanges square, promoting better load on the gasket. Because the shim 10 is placed totally in the outer circumferential region of the flanges, it does not interfere with the gasket, placement of the gasket or compression by the flanges in any manner. As the flange bolts are tightened the shims will deform further providing a visual indication of how much the particular bolt has been tightened. By insuring that the shim deformation is uniform, the installer has a visual indicator that the flange is being properly installed.

Thus the invention provides a visual medium that is readily viewed outside the flange that targets and warns of rotated flanges and “bird beak” flange conditions with its easily discernable pass/fail indication on installation. The product is usable with sizes ½″ 150# through 8″ 150 ANSI raised face flanges and requires no special conditions or changing of any part of the ANSI design.

It is to be understood that the form of the invention shown is a preferred embodiment thereof and that various changes and modifications may be made therein without departing from the spirit of the invention or scope as defined in the following claims.

What I claim is:

1. An article of manufacture for use with flange couplings to provide an indication of proper tightening of flange bolts in such couplings comprising: a mailable blank having a first abutment portion and a second abutment portion, each abutment portion defining therein a bolt hole, a central portion connecting said first and second abutment portions such that said abutment portions are substantially parallel and said bolt holes are substantially coaxially aligned.

2. An article of manufacture as defined in claim 1 wherein said bolt holes receive there through one of said flange bolts and said first and second abutment portions abut opposing flanges in said flange couplings.

3. An article of manufacture as defined in claim 1 wherein said blank has a substantially uniform thickness.

4. An article of manufacture as defined in claim 3 wherein said blank has a substantially uniform width.

5. An article of manufacture as defined in claim 3 wherein said central portion has a reduced width compared to said abutment portions.

6. An article of manufacture as defined in claim 1 wherein said blank is made from a non-corrosive material.

7. An article of manufacture as defined in claim 1 wherein said blank is made from stainless steel.

8. A flange coupling wherein a plurality of the articles of manufacture described in claim 1 are mounted on flange bolts intermediate opposing flanges of said coupling.

9. A flange coupling as defined in claim 8 said bolt holes of each of said plurality of articles of manufacture receive there through one of said flange bolts and said first and second abutment portions thereof abut opposing flanges in said flange couplings.

10. A flange coupling as defined in claim 8 wherein said plurality of articles of manufacture are mounted on flange bolts radially outwardly of a raised face on one or more of said opposing flanges such that said plurality of articles of manufacture are visible during and after installation of said flange coupling.

11. A shim for use in aligning flanges in a flange connection wherein said flanges are connected by bolts passing through a pair of flanges, comprising a pair of opposing abutment portions defining coaxially aligned bolt holes adapted for receiving one of said bolts there through with said opposing abutment portions engaging opposing inner faces of said pair of flanges and a central portion connecting said abutment portions.

12. A shim as defined in claim 11 wherein said shim is made from a mailable material.

13. A shim as defined in claim 12 wherein said mailable material is non-corrosive.

14. A shim as defined in claim 12 wherein said shim is made from stainless steel.

15. A plurality of shims as defined in claim 11 each mounted on associated ones of said bolts intermediate said flanges such that said shims are visible to an installer of said flange connection.
